(19) United States
(12) Patent Application Publication
(10) Pub. No.: US 2025/0121817 A1
(43) Pub. Date: Apr. 17, 2025

(54) METHOD FOR CHECKING AN INFRASTRUCTURE AVP SYSTEM OF A PARKING LOT

(71) Applicant: Robert Bosch GmbH, Stuttgart (DE)

(72) Inventors: Rolf Nicodemus, Bietigheim-Bissingen (DE); Stefan Nordbruch, Leonberg (DE)

(21) Appl. No.: 18/886,443

(22) Filed: Sep. 16, 2024

(30) Foreign Application Priority Data
Oct. 11, 2023 (DE) 10 2023 209 946.2

(51) Int. Cl. B60W 30/06; B60W 30/09; G08G 1/16

(52) U.S. Cl. CPC B60W 30/06; B60W 30/09; G08G 1/168; B60W 2556/45

(57) ABSTRACT

A method for checking an infrastructure AVP system of a parking lot. The infrastructure AVP system is checked using an AVP reference system installed at least partially within the parking lot. An AVP reference system, a computer program, and a machine-readable storage medium are also described.

### CROSS REFERENCE

The present application claims the benefit under 35 U.S.C. § 119 of German Patent Application No. DE 10 2023 209 946.2 filed on Oct. 11, 2023, which is expressly incorporated herein by reference in its entirety.

### FIELD

The present invention relates to a method for checking an infrastructure AVP system of a parking lot, to an AVP reference system, a computer program, and a machine-readable storage medium.

### BACKGROUND INFORMATION

AVP (“automated valet parking”) as a business model/service is, for example, based on the approach that there are multiple vendors for an infrastructure AVP system, analogously to there being various OEMs (original equipment manufacturers) for motor vehicles that are capable of AVP, and that there is a standardized interface between an on-board AVP system in the motor vehicle and an infrastructure AVP system of the parking lot.

The interface as well as the use cases and approval cases for the infrastructure AVP system are generally standardized.

It is advantageous if the infrastructure AVP system is approved for performing AVP processes, after installation.

Such an approval may be performed, for example, by independent organizations in lengthy tests.

China Patent Application No. CN 1 150 092 69 A describers an autonomous parking system.

European Patent Application No. EP 3 852 342 A1 describes a method for automated parking.

### SUMMARY

A task underlying the present invention is to provide a concept for checking an infrastructure AVP system of a parking lot.

This object may be achieved by certain features of the present invention. Advantageous embodiments of the present invention are disclosed herein.

According to a first aspect of the present invention, a method for checking an infrastructure AVP system of a parking lot is provided, wherein the infrastructure AVP system is checked using an AVP reference system installed at least partially within the parking lot.

According to a second aspect of the present invention, an AVP reference system is provided, which is configured to perform all steps of the method according to the first aspect.

According to a third aspect of the present invention, a computer program is provided, comprising instructions that, when the computer program is executed by a computer, in particular by the AVP reference system according to the second aspect, cause the computer to perform a method according to the first aspect.

According to a fourth aspect of the present invention, a machine-readable storage medium is provided, on which the computer program according to the third aspect is stored.

The present invention is based on and includes the finding that the above task is achieved by using an AVP reference system to check the infrastructure AVP system. This serves as a reference for the AVP system to be checked. Ideally, the AVP system to be checked performs an AVP process in the same way as the AVP reference system. In particular, deviations within a predetermined tolerance range are permitted in order nevertheless to approve the AVP system to be checked.

Providing a reference for the AVP system to be checked can in particular bring about a technical advantage of being able to efficiently check whether the AVP system to be checked meets the specifications and requirements necessary for performing AVP processes or not.

The AVP reference system being installed at least partially within the parking lot means in particular that the AVP reference system is installed fully, i.e., entirely, or only partially within the parking lot. In the latter case, one or more parts of the AVP reference system are thus installed within the parking lot, whereas one or more other parts are implemented or installed outside the parking lot.

Parts installed within the parking lot include, for example: environmental sensor(s), communication interface(s), processing device.

According to an example embodiment of the present invention, by means of a communication interface, the AVP reference system can, for example, communicate with an AVP motor vehicle and/or with an environmental sensor.

A communication interface is, for example, a wired communication interface, in particular an Ethernet interface, or is, for example, a wireless communication interface, in particular a radio interface or a WLAN interface.

According to an example embodiment of the present invention, an AVP reference system comprises, for example, a processing device, which may, for example, be installed within the parking lot or may, for example, be implemented within a cloud infrastructure. The processing device may thus even be implemented or installed remotely from the parking lot. Parts of the processing device may, for example, be installed within the parking lot and/or parts of the processing device may, for example, be implemented in a cloud infrastructure.

A processing device within the meaning of the description herein is a data processing device, for example a computer.

The data processing device comprises, for example, multiple computers or servers, which are, for example, installed within the parking lot and/or are, for example, implemented within a cloud infrastructure.

According to an example embodiment of the present invention, the processing device of the AVP reference system receives, for example, the environmental sensor data of the environmental sensors and may, for example, analyze or further process them and perform an AVP process on the basis of the environmental sensor data or on the basis of a result of the analysis or of the further processing.

Analogously to the AVP reference system, the infrastructure AVP system may likewise be installed at least partially within the parking lot, i.e., fully or only partially. The above statements in connection with the AVP reference system apply analogously to the infrastructure AVP system.

For better differentiation, parts of the AVP reference system may be referred to as reference parts, i.e., for example, as a reference communication interface or as a reference environmental sensor or as a reference processing device.

The infrastructure AVP system may also be referred to as an AVP system to be checked.

Environmental sensors may, for example, be connected to a processing device via a wired communication connection, for example via an Ethernet line.

In one example embodiment of the method of the present invention, it is provided that the AVP reference system performs an AVP reference process with an AVP motor vehicle within the parking lot, but normally without the AVP reference system sending control commands to the AVP motor vehicle for at least highly automated control of a lateral and longitudinal guidance of the AVP motor vehicle, wherein the check comprises that an AVP process performed by the infrastructure AVP system with the AVP motor vehicle within the parking lot is checked by the AVP reference system on the basis of the AVP reference process.

This, for example, brings about a technical advantage that the check can be performed efficiently. This, in particular, brings about the technical advantage of being able to efficiently check whether the AVP system to be checked meets the requirements and specifications regarding the performance of AVP processes.

In one example embodiment of the method of the present invention, it is provided that reference process data are ascertained by the AVP reference system on the basis of the AVP reference process, wherein the check comprises comparing, by the AVP reference system, the reference process data to process data ascertained by the infrastructure AVP system on the basis of the AVP process.

This, for example, brings about a technical advantage that the check can be performed efficiently.

In one example embodiment of the method of the present invention, it is provided that the process data and the reference process data respectively comprise one or more of the following data: object data, which describe objects recognized by the corresponding AVP system; free space recognition data, which describe a free space determined by the corresponding AVP system in the environment of the AVP motor vehicle; behavioral data of the AVP motor vehicle, which describe a behavior of the AVP motor vehicle that has been recognized by the corresponding AVP system; communication data, which indicate a particular status of a communication between the AVP motor vehicle and at least one of the two AVP systems and/or a particular status of a communication between an AVP reference motor vehicle and at least one of the two AVP systems. For example, the status indicates whether the communication is still present or still functioning. The AVP reference motor vehicle is described below.

This, for example, brings about a technical advantage that particularly suitable process data can be used.

In one example embodiment of the method of the present invention, it is provided that the AVP reference system specifies one or more tests to be performed as part of the AVP process, wherein the infrastructure AVP system is checked by the AVP reference system on the basis of a particular test result.

This, for example, brings about a technical advantage that the check can be performed efficiently. In particular, it can thus be efficiently checked whether the AVP system to be checked meets certain requirements with regard to the performance of AVP processes.

In one example embodiment of the method of the present invention, it is provided that the one or more tests to be performed respectively is/are an element selected from the following group of tests: performing a ramp drive as part of the AVP process of the AVP motor vehicle; testing a response of the infrastructure AVP system to an object appearing directly in the travel route envelope of the AVP motor vehicle during the AVP process; testing a response of the infrastructure AVP system to an object located within the travel route envelope and having at most a predetermined maximum size and/or to an object located within the travel route envelope and having at least a predetermined minimum size; testing a communication between the AVP motor vehicle and at least one of the two AVP systems; testing a communication between an AVP reference motor vehicle and at least one of the two AVP systems; checking whether the AVP motor vehicle and/or an AVP reference motor vehicle has been correctly identified by the infrastructure AVP system, in particular at the beginning and/or during the AVP process. The AVP reference motor vehicle is described below. The beginning of the AVP process in particular takes place at a start position. In other words, the AVP process begins at a start position, which may also be referred to as the drop-off position, which is further described below.

This, for example, brings about a technical advantage that particularly suitable tests can be performed. In particular, performing a ramp drive as part of the AVP process of the AVP motor vehicle is a particularly useful test since a ramp drive generally requires a particularly high degree of safety and care when performing an AVP process. The same also applies to the other tests mentioned above, which can likewise efficiently increase safety for other people located within the parking lot. Testing of the particular communication in particular comprises testing whether the particular communication is still present or still functioning, i.e., whether a particular communication connection is established, for example.

In one example embodiment of the method of the present invention, it is provided that, if an error that occurs when the AVP process is performed by the infrastructure AVP system is detected, and/or if a potential collision of the AVP motor vehicle that would occur with a collision object in its environment if the AVP motor vehicle were to drive according to the AVP process is recognized, an emergency stop command is sent to the AVP motor vehicle by the AVP reference system.

This, for example, brings about a technical advantage that safety for the AVP motor vehicle and/or for an environment of the AVP motor vehicle can be efficiently increased.

The above-described normal case in particular describes the situation in which no error in the infrastructure AVP system is detected and/or in which no potential collision of the AVP motor vehicle that would occur with a collision object in its environment if the AVP motor vehicle were to drive according to the AVP process is recognized.

In one example embodiment of the method of the present invention, it is provided that one or more or all method steps and/or data ascertained for the check are documented, in particular documented in a block chain.

This, for example, brings about a technical advantage that it can be efficiently tracked, even at a later time, what was performed or ascertained when and how. In particular, the AVP process can thereby be efficiently tracked, even at a later time. In particular, an error analysis of the AVP process can be efficiently performed at a later time.

The term “data ascertained for the check” is in particular understood to mean the aforementioned process data and/or test results.

Documenting in a block chain in particular has the technical advantage that subsequent manipulations of the documented data can be efficiently recognized.

In one example embodiment of the method of the present invention, it is provided that the infrastructure AVP system and the AVP reference system respectively comprise their own environmental sensors, which are arranged, spatially distributed, within the parking lot, wherein the infrastructure AVP system is checked by the AVP reference system on the basis of environmental sensor data from at least some of the environmental sensors.

This, for example, brings about a technical advantage that the check can be performed efficiently.

In one example embodiment of the method of the present invention, it is provided that an AVP reference motor vehicle is used for checking.

This, for example, brings about a technical advantage that the check can be performed efficiently.

The AVP reference motor vehicle may, for example, comprise additional environmental sensors and/or computers or processors that the AVP motor vehicle does not have, so that the AVP reference motor vehicle can process additional data, in particular environmental sensor data, for the check.

A parking lot within the meaning of the description may also be referred to as a parking area or a parking facility and serves as an area for parking motor vehicles. The parking lot thus forms, for example, a contiguous area, which comprises multiple parking spaces (for a parking lot on private ground) or parking places (for a parking lot on public ground). The parking lot is, for example, a parking structure or is, for example, a parking garage. The parking structure may, for example, comprise an underground parking garage.

A parking lot within the meaning of the description in particular comprises roadways, entrances, and exits.

The abbreviation AVP stands for “automated valet parking” and can be translated into German as “automatischer Parkservice.” As part of an AVP process, the motor vehicle is, for example, guided by the infrastructure AVP system from a drop-off position to a parking position, parked at the parking position, and, for example, after the end of a parking time or, for example, in response to a pick-up request, is maneuvered out of the parking position and guided to a pick-up position. The AVP process begins at the drop-off position. The AVP process ends at the pick-up position.

A motor vehicle within the meaning of the description is an AVP motor vehicle even if this is not explicitly described. Such a motor vehicle is configured to perform an AVP process.

If the motor vehicle drives within the AVP process, this is at least highly automated driving. The phrase “at least highly automated” includes the following phrases: highly automated, fully automated, and autonomous.

Highly automated driving corresponds to a level of automation 3 according to the definition by the Federal Highway Research Institute (BASt).

Fully automated driving corresponds to a level of automation 4 according to the definition by the BASt.

Autonomous driving corresponds to a level of automation 5 according to SAE (J3016), where SAE stands for “Society of Automotive Engineers.”

Further explanations regarding an AVP process are described, for example, in ISO 23374-2.

Statements made in connection with the AVP reference system apply analogously to the method, and vice versa.

The AVP reference system is, for example, configured programmatically to execute the computer program.

The method is, for example, a computer-implemented method.

The method is, for example, performed by means of the AVP reference system.

The phrase “at least one” means “one or more.”

An environmental sensor within the meaning of the description is, for example, one of the following environmental sensors: radar sensor, ultrasonic sensor, LIDAR sensor, magnetic field sensor, infrared sensor, image sensor, in particular image sensor of a video camera.

The embodiment examples and embodiments described here of the present invention can be combined with one another in any way even if this is not explicitly described.

In one example embodiment of the method of the present invention, it is provided that, on the basis of the check, the infrastructure AVP system is approved for performing AVP processes within the parking lot.

This, for example, brings about the technical advantage that the approval can be performed efficiently.

The present invention is explained in more detail below using preferred embodiment examples.

### BRIEF DESCRIPTION OF THE DRAWINGS

FIG. 1 shows a flowchart of an example method according to the first aspect of the present invention.

FIG. 2 shows an AVP reference system, according to an example embodiment of the present invention.

FIG. 3 shows a machine-readable storage medium, according to an example embodiment of the present invention.

FIG. 4 shows a parking lot.

FIG. 5 shows multiple video cameras.

FIG. 6 shows an AVP motor vehicle and an AVP reference motor vehicle, according to an example embodiment of the present invention.

### DETAILED DESCRIPTION OF EXAMPLE EMBODIMENTS

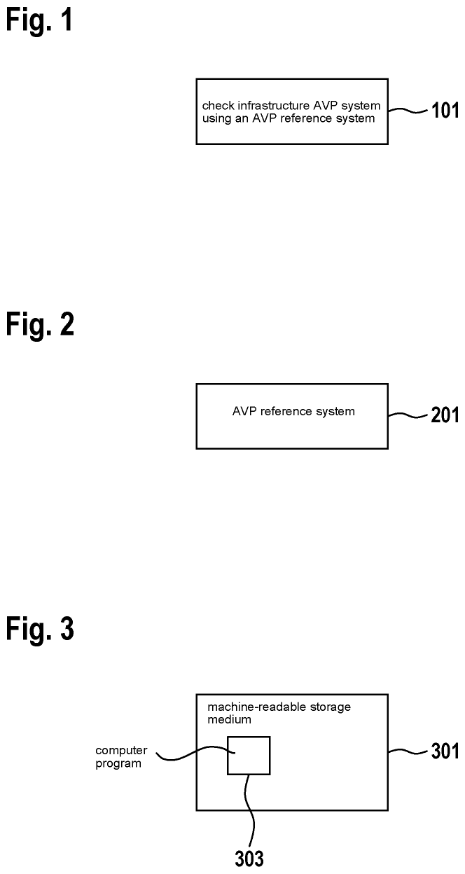

FIG. 1 shows a flow chart of a method for checking an infrastructure AVP system of a parking lot, wherein the infrastructure AVP system is checked 101 using an AVP reference system installed at least partially within the parking lot.

The phrase “installed at least partially” includes the phrases “partially” and “fully installed.”

The AVP reference system being partially installed within the parking lot means, for example, that one or more parts, for example environmental sensors, communication interface(s), processing device, of the AVP reference system are installed within the parking lot, with one or more parts being installed outside the parking lot. For example, a processing device is implemented in a cloud infrastructure.

A processing device may, for example, comprise multiple computers, at least one of which is, for example, implemented in a cloud infrastructure and at least one of which is, for example, installed within the parking lot.

The AVP reference system being fully installed within the parking lot means, for example, that all parts, for example environmental sensors, communication interface(s), processing device, of the AVP reference system are installed within the parking lot.

FIG. 2 shows an AVP reference system 201, which is configured to perform all steps of the method according to the first aspect.

The AVP reference system comprises, for example, multiple environmental sensors (not shown) installed within the parking lot. The multiple environmental sensors are, for example, fixedly installed or are, for example, movably installed within the parking lot. For example, some of these environmental sensors are fixedly installed and some of these environmental sensors are movably installed.

For example, the AVP reference system 201 comprises one or more environmental sensors (not shown) installed within the parking lot. Communication with an AVP motor vehicle and/or with an AVP reference motor vehicle is, for example, made possible via the communication interface.

For example, the AVP reference system 201 comprises a processing device (not shown), which may, for example, be implemented in a cloud infrastructure or which may, for example, be installed within the parking lot. The processing device, for example, communicates with an AVP motor vehicle and/or with an AVP reference motor vehicle via the communication interface(s).

Communicating comprises, for example, sending an emergency stop command to the AVP motor vehicle and/or to the AVP reference motor vehicle.

FIG. 3 shows a machine-readable storage medium 301, on which a computer program 303 is stored. The computer program 303 comprises instructions that, when the computer program 303 is executed by a computer, cause the computer to perform a method according to the first aspect.

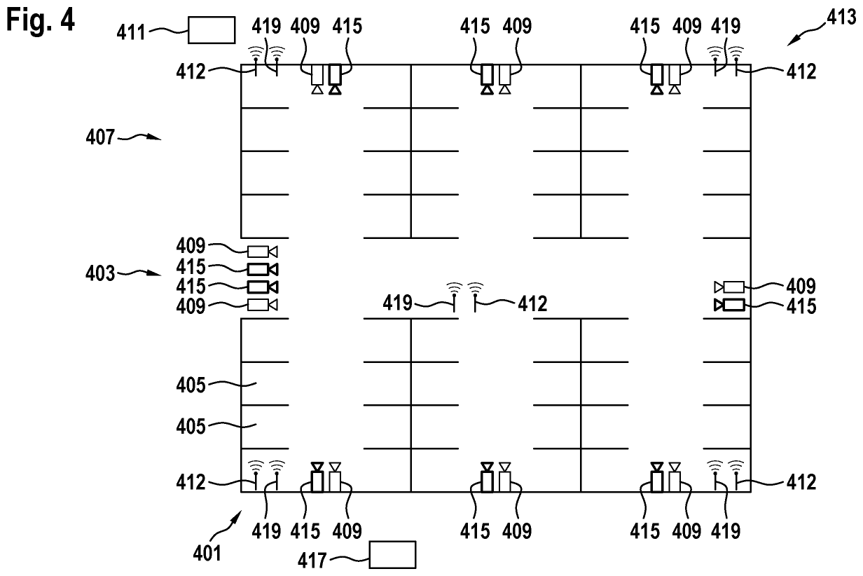

FIG. 4 shows a parking lot 401 comprising a common entrance/exit 403 as well as multiple parking spaces 405 for motor vehicles.

Furthermore, an AVP system 407 to be checked is assigned to the parking lot 401. The AVP system 407 to be checked comprises multiple video cameras 409 installed within the parking lot 401. The video cameras 409 are an example of environmental sensors. In addition or instead of the video cameras 409, other environmental sensors may be provided.

Furthermore, the AVP system 407 to be checked comprises a processing device 411, which communicates with the video cameras 409. The AVP system 407 to be checked comprises multiple wireless communication interfaces 412 arranged, spatially distributed, within the parking lot 401. Communication with an AVP motor vehicle may take place via these wireless communication interfaces 412.

The processing device 411 may, for example, ascertain control commands and send them wirelessly by means of the wireless communication interfaces 412 to the AVP motor vehicle as part of an AVP process.

An AVP reference system 413 is provided for checking the AVP system 407. The AVP reference system 413 comprises multiple video cameras 415 installed within the parking lot 401, next to the video cameras 409 of the AVP system 407 to be checked.

Furthermore, the AVP reference system 413 comprises a processing device 417, which can, for example, process the video data of the video cameras 415.

Analogously, the processing device 411 of the AVP system 407 to be checked can process the video data of the video cameras 409.

Furthermore, the AVP reference system 413 comprises multiple wireless communication interfaces 419 arranged, spatially distributed, within the parking lot 401, next to the wireless communication interfaces 412 of the AVP system 407 to be checked.

Via these wireless communication interfaces 419, the processing device 417 can, for example, communicate with an AVP motor vehicle, for example send an emergency stop command to the AVP motor vehicle.

According to the concept described here, it is, for example, provided that both the AVP system 407 to be checked and the AVP reference system 413 respectively perform their own AVP process with an AVP motor vehicle within the parking lot. However, the AVP reference system 413 normally does not send control commands to the AVP motor vehicle but only intervenes in an emergency.

As part of the AVP process, process data are ascertained by each of the two AVP systems 407, 413 and are compared to one another by the AVP system 407 to be checked, after the AVP process has been performed and/or while the AVP process is still being performed, in particular in real-time. On the basis of the comparison, it may, for example, be determined whether or not the AVP system 407 to be checked has passed the check and whether or not it is accordingly approved for performing AVP processes.

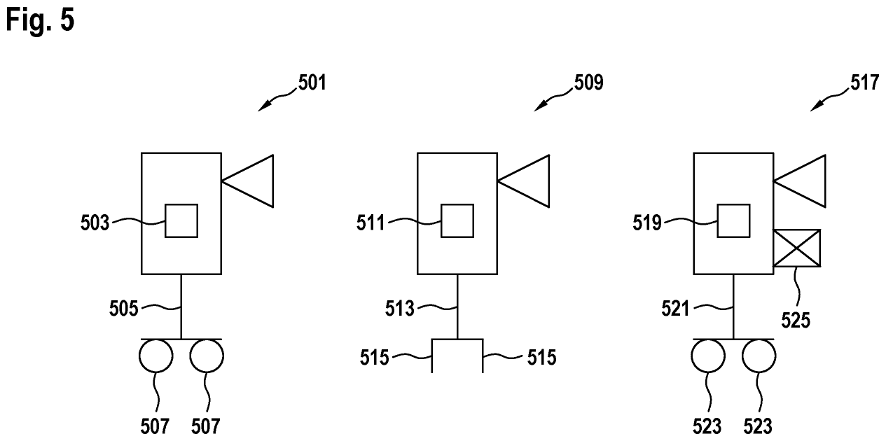

FIG. 5 shows multiple video cameras.

Specifically, a first video camera 501 comprising a first image sensor 503 is shown. The first video camera 501 is installed on a frame or tripod 505 with rollers 507. The first video camera 501 can thus be rolled through the parking lot to a particular position.

Furthermore, FIG. 5 shows a second video camera 509 comprising a second image sensor 511. The second video camera 509 is fastened to a frame or tripod 513 and has feet 515 but no rollers. The second video camera 509 thus cannot be rolled within the parking lot to a particular position.

Furthermore, FIG. 5 shows a third video camera 517 comprising a third image sensor 519. The third video camera 517 is fastened to a further frame 521 comprising rollers 523. The third video camera 517 can thus be rolled within the parking lot to a particular position. A further environmental sensor, for example a LiDAR sensor, 525, is arranged at the third video camera 517. For an AVP process, LiDAR data are thus available in addition to video data.

The video cameras 501, 509, 517 shown in FIG. 5 are, for example, comprised by an AVP reference system within the meaning of the description.

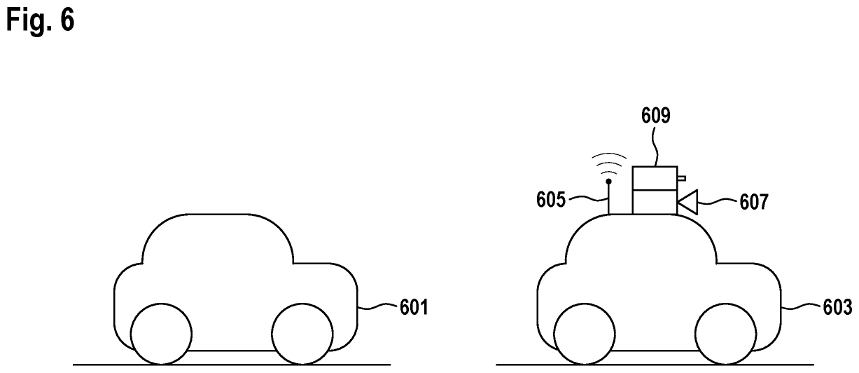

FIG. 6 shows an AVP motor vehicle 601. The AVP motor vehicle 601 comprises environmental sensors (not shown) and an on-board AVP system in order to be able to perform an AVP process in cooperation with an infrastructure AVP system.

FIG. 6 furthermore shows an AVP reference motor vehicle 603, which comprises additional environmental sensors or analysis capabilities in comparison to a standard AVP motor vehicle, such as the AVP motor vehicle 601, in order to check an infrastructure AVP system in cooperation with an AVP reference system.

The AVP reference motor vehicle 603 comprises, for example, a wireless communication interface 605 as well as a reference video camera 607 and a data processing device 609 for analyzing the AVP process.

In particular, the concept described here has the advantage that an approval of an infrastructure AVP system of a parking lot for performing AVP processes with AVP motor vehicles within the parking lot can be simplified and/or supported by the AVP reference system. The AVP reference system is in particular used as a reference for the AVP process. The AVP reference system may, for example, be used as a documentation system, i.e., may be used for documenting, for example.

The concept described here is in particular based on using a further AVP system, the AVP reference system, as a reference for the infrastructure AVP system of the parking lot.

The AVP reference system may, for example, be a movable system. The term “movable” means that the AVP reference system or parts of the AVP reference system are not permanently fixedly installed within the parking lot but are only installed within the parking lot for the method.

For example, the AVP reference system is installed at least partially temporarily within the parking lot. The term “temporarily” thus means that the AVP reference system or parts thereof are installed within the parking lot only for the method. After the method has been completed, it is thus, for example, provided that the AVP reference system or the installed parts of the AVP reference system are removed.

The AVP reference system is, for example, approved or certified for performing AVP processes with AVP motor vehicles. The approval or the certifications are, for example, repeated regularly, for example every 2 years.

It is, for example, provided that, after installation of the infrastructure AVP system or of parts thereof within the parking lot, the AVP reference system or parts thereof are installed within the parking lot in order to check the infrastructure AVP system.

It is, for example, provided that an infrastructure AVP system that in the past has already been approved for performing AVP processes with AVP motor vehicles within the parking lot is checked again according to the concept described here.

The AVP reference system has, for example, the same tasks as the infrastructure AVP system, with the exception that the AVP reference system normally does not control the AVP motor vehicle.

For example, the AVP reference system can also be used as an emergency stop system in the case of a (critical) error. This, for example, if the AVP motor vehicle were to have an accident, for example, on the basis of the control by the infrastructure AVP system.

During and/or after the AVP process, correctness of the AVP process and/or of the analyzed/ascertained process data of the two AVP systems are compared to one another, for example.

Process data comprise in particular: object data, which describe objects recognized by the corresponding AVP system; free space recognition data, which describe a free space determined by the corresponding AVP system in the environment of the AVP motor vehicle; and/or behavioral data of the AVP motor vehicle, which describe a behavior of the AVP motor vehicle that has been recognized by the corresponding AVP system;

communication data, which indicate a particular status of a communication between the AVP motor vehicle and at least one of the two AVP systems and/or a particular status of a communication between an AVP reference motor vehicle and at least one of the two AVP systems. For example, the status indicates whether the communication is still present or still functioning.

One or more of the following tests are, for example, performed during the AVP process: performing a ramp drive as part of the AVP process of the AVP motor vehicle; testing a response of the infrastructure AVP system to an object appearing directly in the travel route envelope of the AVP motor vehicle during the AVP process; testing a response of the infrastructure AVP system to an object located within the travel route envelope and having at most a predetermined maximum size and/or to an object located within the travel route envelope and having at least a predetermined minimum size; testing a communication between the AVP motor vehicle and at least one of the two AVP systems; testing a communication between an AVP reference motor vehicle and at least one of the two AVP systems; checking whether the AVP motor vehicle and/or an AVP reference motor vehicle has been correctly identified by the infrastructure AVP system, in particular at the beginning and/or during the AVP process.

For example, an object is moved into the travel route envelope of the AVP motor vehicle in such a way that it appears directly in the travel route envelope.

Such an object is, for example: ball or stroller.

The process data and/or the results of the test(s) and/or the results of the comparison(s) may, for example, be used for an approval of the infrastructure AVP system.

An approval or certificate is, for example, granted if, for example, evidence has been provided that, for example, the AVP process performed by the infrastructure AVP system was correct, and/or if, for example, evidence has been provided that, for example, all process data are consistent within a defined tolerance range, and/or if, for example, evidence has been provided that, for example, all tests have been passed.

One or more or all method steps and/or data ascertained for the check, in particular process data and/or test results, are, for example, documented, in particular documented in a block chain.

For example, it is provided that, in the case of one or more errors in the infrastructure AVP system, the AVP reference system is used for error analysis or to support the error analysis.

Environmental sensors of the AVP reference system may, for example, be arranged at the same locations as or next to environmental sensors of the infrastructure AVP system and/or at other locations.

In particular, it is provided that the environmental sensors of the two AVP systems can sense all areas of the parking lot that are relevant to the performance of the AVP process. Such relevant areas comprise, for example: roadway, parking spaces, entrance(s) and/or exit(s).

The environmental sensors of the AVP reference system may, for example, be temporarily fastened or may be movable by positioning technology, for example be fastened onto rollers or tripods.

The environmental sensors of the AVP reference system may, for example, have the same technology as environmental sensors of the infrastructure AVP system, such as identical cameras, i.e., for example, of the same manufacturer and the same brand.

The environmental sensors of the AVP reference system may, for example, have the same technology but originate from different manufacturers.

The environmental sensors of the AVP reference system may, for example, have different technologies (for example, cameras and lidar sensors).

The environmental sensors of the AVP reference system may, for example, comprise the additional environmental sensors that the infrastructure AVP system does not have. For example, the infrastructure AVP system only comprises cameras as environmental sensors, whereas the AVP reference system comprises cameras and lidar sensors.

For example, it may be provided to use an AVP reference motor vehicle in addition to the AVP reference system for the check. The AVP reference motor vehicle is, for example, a special vehicle, i.e., in particular not a standard AVP motor vehicle, with further environmental sensors and/or analysis capabilities. Such an AVP reference motor vehicle may, for example, be used for further tests and/or inspections.

What is claimed is:

1. A method for checking an infrastructure automated valet parking (AVP) system of a parking lot, comprising:
checking the infrastructure AVP system using an AVP reference system installed at least partially within the parking lot.

2. The method according to claim 1, wherein the AVP reference system performs an AVP reference process with an AVP motor vehicle within the parking lot, but normally without the AVP reference system sending control commands to the AVP motor vehicle for at least highly automated control of a lateral and longitudinal guidance of the AVP motor vehicle, wherein the check includes that an AVP process performed by the infrastructure AVP system with the AVP motor vehicle within the parking lot is checked by the AVP reference system based on the the AVP reference process.

3. The method according to claim 2, wherein reference process data are ascertained by the AVP reference system based on the AVP reference process, wherein the check includes comparing, by the AVP reference system, the reference process data to process data ascertained by the infrastructure AVP system based on the AVP process.

4. The method according to claim 3, wherein the process data and the reference process data respectively include one or more of the following data: (i) object data which describe objects recognized by a corresponding AVP system of the infrastructure AVP system or the AVP reference system, (ii) free space recognition data which describe a free space determined by the corresponding AVP system in an environment of the AVP motor vehicle, (iii) behavioral data of the AVP motor vehicle which describe a behavior of the AVP motor vehicle that has been recognized by the corresponding AVP system, (iv) communication data, which indicate a particular status of a communication between the AVP motor vehicle and at least one of the infrastructure AVP system and the AVP reference system and/or a particular status of a communication between an AVP reference motor vehicle and at least one of the infrastructure AVP system and the AVP reference system.

5. The method according to claim 2, wherein the AVP reference system specifies one or more tests to be performed as part of the AVP process, wherein the infrastructure AVP system is checked by the AVP reference system based on a particular test result.

6. The method according to claim 5, wherein the one or more tests to be performed respectively include an element selected from the following group of tests: (i) performing a ramp drive as part of the AVP process of the AVP motor vehicle, (ii) testing a response of the infrastructure AVP system to an object appearing directly in a travel route envelope of the AVP motor vehicle during the AVP process, (iii) testing a response of the infrastructure AVP system to an object located within the travel route envelope and having at most a predetermined maximum size and/or to an object located within the travel route envelope and having at least a predetermined minimum size, (iv) testing a communication between the AVP motor vehicle and at least one of the infrastructure AVP system and the reference AVP system, (v) testing a communication between an AVP reference motor vehicle and at least one of the infrastructure AVP system and the reference AVP system, (vi) checking whether the AVP motor vehicle and/or an AVP reference motor vehicle has been correctly identified by the infrastructure AVP system at a beginning and/or during the AVP process.

7. The method according to claim 2, wherein, when an error that occurs when the AVP process is performed by the infrastructure AVP system is detected, and/or when a potential collision of the AVP motor vehicle that would occur with a collision object in its environment when the AVP motor vehicle were to drive according to the AVP process is recognized, an emergency stop command is sent to the AVP motor vehicle by the AVP reference system.

8. The method according to claim 1, wherein one or more or all method steps and/or data ascertained for the check are documented in a block chain.

9. The method according to claim 1, wherein, based on the check, the infrastructure AVP system is approved for performing AVP processes within the parking lot.

10. The method according to claim 1, wherein the infrastructure AVP system and the AVP reference system respectively include their own respective environmental sensors, which are arranged, spatially distributed, within the parking lot, wherein the infrastructure AVP system is checked by the AVP reference system based on environmental sensor data from at least some of the environmental sensors.

11. The method according to claim 1, wherein an AVP reference motor vehicle is used for the check.

12. An automated valet parking (AVP} reference system configured to check an infrastructure automated valet parking (AVP) system of a parking lot, the AVP reference system being installed at least partially within the parking lot.

13. A non-transitory machine-readable storage medium on which is stored a computer program for checking an infrastructure automated valet parking (AVP) system of a parking lot, the computer program, when executed by a computer, causing the computer to perform the following:
checking the infrastructure AVP system using an AVP reference system installed at least partially within the parking lot.
